(19) United States
(12) Patent Application Publication
(10) Pub. No.: US 2022/0132807 A1
(43) Pub. Date: May 5, 2022

(54) Connecting Link for Animal Harness

(71) Applicant: Joseph S Sporn, New York, NY (US)

(72) Inventor: Joseph S Sporn, New York, NY (US)

(21) Appl. No.: 17/088,980

(22) Filed: Nov. 4, 2020

(51) Int. Cl. A01K 27/00

(52) U.S. Cl. CPC A01K 27/002

(57) ABSTRACT

The present invention is a novel connecting link interconnecting the spaced apart forechest straps of an animal harness where the link includes an elongated elastic band whose terminal ends are slidingly attached to the respective forechest straps with a modified triglide slide and an elongated non-elastic band having a length greater than the length of the elastic band whose terminal ends are also slidingly attached to the respective forechest straps.

The present invention relates to animal harnesses and more specifically to a linking assembly for interconnecting the forechest straps of certain types of animal harnesses.

### BACKGROUND

The need for a comfortable non-chaffing animal harness which also advance good control of the animal, when paired with a leash, has been the motivation for a multitude of harness designs. Some of those harness designs incorporate a pair of straps which descend over the forechest of the animal from a variety of assemblies over the animal's withers or other harness structures. Typically, the descending forechest straps are then routed under the animal's forelegs to connect with another part of the harness. In order to maintain the forechest straps in position, the straps are typically interconnected over the forechest. Such interconnection can take several forms including a pad, a section of mesh or other device which will interconnect the straps but at the same time provide the forechest straps with the freedom to move lengthwise with respect to one another. A traditional triglide slide that interconnects the forechest straps is one such device. One disadvantage of a connecting device such as the triglide slide is that the forechest straps are bound close together in a V shaped configuration which causes chaffing on the animal's forechest as the animal moves.

Accordingly, the object of the present invention is provide an interconnection of the forechest straps of an animal harness that spreads the straps to avoid a V shape of the interconnection and also allows the straps to move longitudinally with respect to one another. Yet another and significant object of the invention is to provide an elastic linkage for harness forechest straps that allows expansion and reduction of the distance between the straps to accommodate the animal's natural movements and offer increased comfort to the animal.

### BRIEF DESCRIPTION OF THE INVENTION

In an animal harness having spaced apart forechest straps, a link interconnecting the forechest straps which link includes an elongated elastic band whose terminal ends are slidingly attached to the respective forechest straps, together with a paired elongated non-elastic band whose terminal ends are also slidingly attached to the respective forechest straps and is of greater length than the elastic band in its quiescent condition.

### DESCRIPTION OF THE DRAWINGS

FIG. 1 is typical of the prior art, illustrating the forechest and forelegs of an animal with harness forechest straps interconnected with a triglide slide.

FIG. 2 is a front view of an animal's forechest and forelegs with the connecting link of the present invention interconnecting the forechest straps of a harness.

FIG. 3 is an enlarged back side view of the connecting link of the present invention illustrating the modified triglide slides that slidingly interconnect the elastic and non-elastic connecting bands with the respective forechest straps.

FIG. 4 is a top view of the connecting link.

FIG. 5 is a plan view of the modified triglide slide of the present invention.

### DETAILED DESCRIPTION OF PREFERRED EMBODIMENT

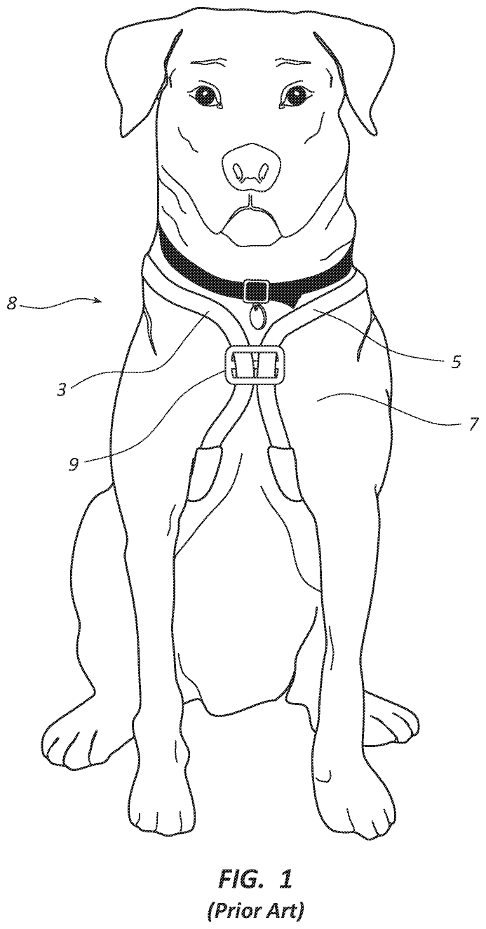

An example of a prior art connecting link is shown in FIG. 1 where typical forechest straps 3 and 5 of an animal harness (not shown) depend over the forechest 7 of a dog 8. The forechest straps are interconnected by a triglide slide 9.

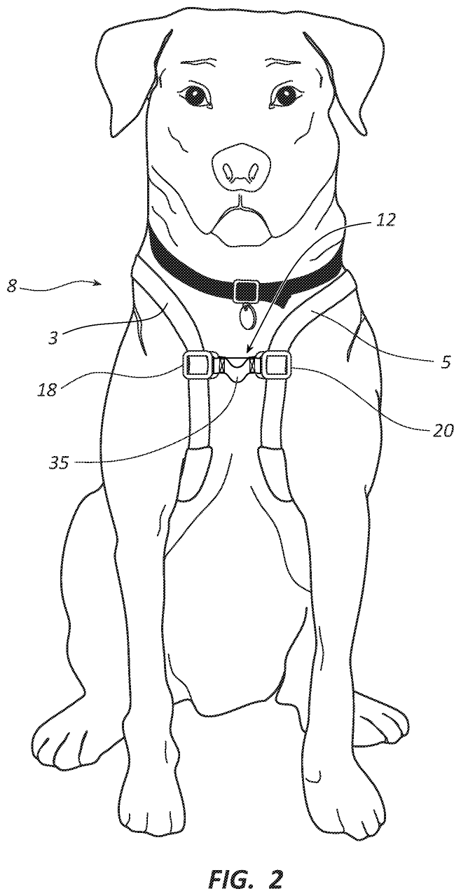

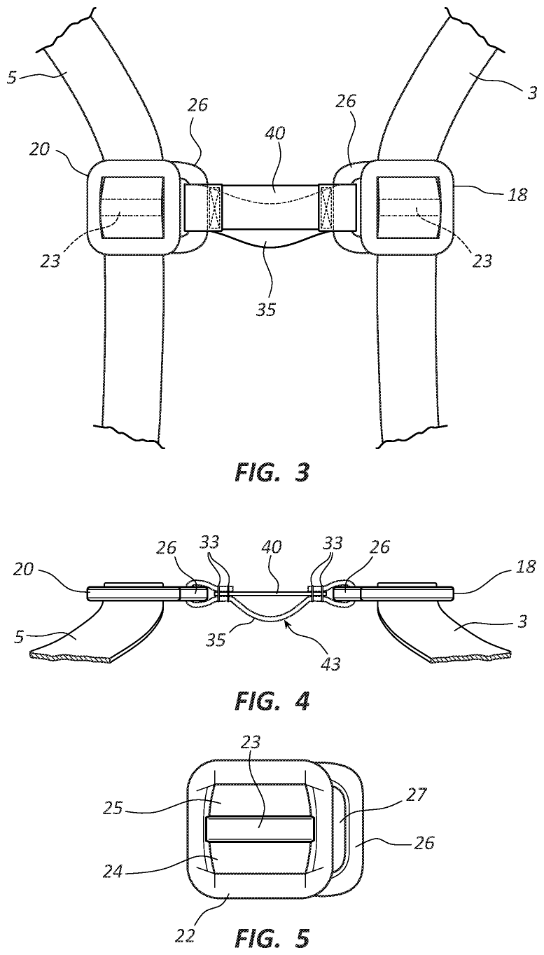

FIG. 2 illustrates the expandable connecting link 12 of the present invention which interconnects the forechest straps 3 and 5 of an animal harness (complete harness not shown). The terminal ends of the connecting link 12 are slidingly interconnected to the respective forechest straps by modified triglide slides 18 and 20, the details of one of which are shown in FIG. 5. Each modified slide comprises the traditional outer frame 22 having a central cross member 23 which define mutually parallel elongated mouths 24 and 25 through which a forechest strap is trained. Attached laterally to a side leg of the frame 22 is a second frame member 26 that encloses an elongated mouth 27 whose lengthwise dimension is perpendicular to the lengthwise dimension of the triglide mouths 24 and 25. As shown in FIG. 4, the terminal ends 33 of an elongated non-elastic web member 35 are trained through the laterally disposed triglide mouths 27 of the respective modified triglide slides 18 and 20 and are folded back upon the body of the web member and stitched or otherwise attached thereto forming a secured connection between the terminal ends of the non-elastic web member 35 and the modified triglide slides 18 and 20.

Facing the web member 35 is an elastic band 40 disposed behind the web member and in between the modified triglide slides 18 and 20. The terminal ends of the elastic band are secured between the stitched-together folded-back ends 33 and the body of the web member 35. The length of the elastic band 40, between the points of attachment of its terminal ends, in its quiescent non-stretched condition, is shorter than the length of the non-elastic web member 35 between its secured folded-back ends. The discrepancy in lengths of the elastic band and the non-elastic web member creates a bow 43 in the web member.

The objective of flexibility in the connecting link, when the harnessed animal is in motion, is created when the elastic band 40 stretches to allow the forechest straps to separate. As the band 40 stretches the bow 43 in the web member 35 tends to straighten and ultimately comes to its straight length, thus limiting the stretch of the elastic band and limiting the separation of the forechest straps. In addition to its separation-limiting function, the web member acts as a back-up structure to keep the forechest straps together in the event the elastic band should fail.

I claim:

1. In an animal harness,
spaced apart forechest straps,
a link interconnecting the forechest straps, said link having,
an elongated elastic band having a length and terminal ends, which terminal ends are slidingly attached to the respective forechest straps,
an elongated non-elastic band having a length greater than the length of the elastic band and having terminal ends slidingly attached to the respective forechest straps.

2. The harness of claim 1 where the points of attachment of the terminal ends of the elastic band to the respective forechest straps are the same points of attachment as the terminal ends of the non-elastic band to the respective forechest straps.

3. A connecting link for an animal harness comprising,
a pair of spaced apart triglide slides having mutually parallel elongated mouths, each having an elongated laterally disposed mouth where the lengthwise dimension of the lateral mouth is perpendicular to the lengthwise dimension of the parallel mouths of the slides,
a strip of webbing having terminal ends where each of the terminal ends pass through the respective lateral mouths of the triglide slides and is folded back onto itself and secured thereto,
a strip of elastic material having terminal ends which ends are secured to the folded back portion of the webbing strip, said elastic strip disposed in parallel relation to the strip of webbing material and being shorter in length than the strip of webbing material.

4. In an animal harness comprising,
spaced apart forechest straps,
a link interconnecting the forechest straps, said link having,
a pair of spaced apart triglide slides having mutually parallel mouths though which the respective forechest straps pass, each of said triglide slides having an elongated laterally disposed mouth where the lengthwise dimension of the lateral mouth is perpendicular to the parallel mouths of the slides,
a strip of webbing having terminal ends where each of the terminal ends pass through the respective lateral mouths of the triglide slides and is folded back onto itself and secured thereto,
a strip of elastic material having terminal ends which ends are secured to the folded back portion of the webbing strip, said elastic strip disposed in parallel relation to the strip of webbing material and being shorter in length than the strip of webbing material.
